(19) United States
(12) Patent Application Publication
(10) Pub. No.: US 2006/0274206 A1
(43) Pub. Date: Dec. 7, 2006

(54) DISPLAY APPARATUS HAVING ADJUSTABLE PIP FUNCTION AND CONTROL METHOD THEREOF

(76) Inventors: Seung-ho Jang, Suwon-si (KR); Il-ki Min, Anyang-si (KR)

Correspondence Address: STANZIONE & KIM, LLP, 919 18TH STREET, N.W., SUITE 440, WASHINGTON, DC, 20006, US

(21) Appl. No.: 11/382,955

(22) Filed: May 12, 2006

(30) Foreign Application Priority Data
Jun. 1, 2005 (KR) 2005-46792

(51) Int. Cl. H04N 5/45

(52) U.S. Cl. 348/565

(57) ABSTRACT

A control method of a display apparatus having a video signal processing unit to process input first and second video signals in a PIP mode, and a display unit on which the first and second video signals processed by the video signal processing unit are displayed, includes processing the first and the second video signals in the PIP mode when a PIP function is selected, and displaying the first video signal as a main screen and the second video signal as a sub screen on the display unit, and adjusting transparency of the sub screen when predetermined conditions are satisfied. Adjustment of the transparency of the sub screen improves user's convenience in viewing the main screen in the PIP mode.

### CROSS-REFERENCE TO RELATED APPLICATIONS

This application claims the benefit under 35 U.S.C. § 119 of Korean Patent Application No. 2005-46792, filed on Jun. 14, 2005, in the Korean Intellectual Property Office, which is incorporated herein by reference in its entirety.

### BACKGROUND OF THE INVENTION

1. Field of the Invention

The present general inventive concept relates to a display apparatus and a control method thereof, and more particularly, to a display apparatus having a picture in picture (PIP) function with an adjustable transparency of a sub screen, and a control method thereof.

2. Description of the Related Art

Recently, display apparatuses support a picture in picture (PIP) function whereby two screens (images) are displayed on a display functioning in a PIP display mode. According to the PIP display mode, video signals input from two or more video signal sources are processed, and two screens (images), a larger-sized main screen and a sub or PIP screen having a size that is 1/n the size of the main screen, can be displayed on a display.

In a display apparatus that supports the PIP function, since a part of the main screen is covered by the sub (or PIP) screen, it is not possible for a user to view all portions of the main screen.

In a conventional display apparatus supporting the PIP function, some methods to overcome this inconvenience have been considered. For example, color texture and motion of the main screen are analyzed and the sub screen is moved to a portion of the main screen having less importance than the other portions of the main screen, or, alternatively, the size of the sub screen is adjusted.

However, according to the above described conventional methods, a portion of the main screen remains covered by the sub screen, which is still displayed even when a video signal corresponding to the sub screen is not input, thereby the inconvenience persists.

### SUMMARY OF THE INVENTION

The present general inventive concept provides a display apparatus and a control method of the same, capable of adjusting a transparency of a sub screen when the display apparatus functions in a PIP mode.

Additional aspects and advantages of the present general inventive concept will be set forth in part in the description which follows and, in part, will be obvious from the description, or may be learned by practice of the general inventive concept.

The foregoing and/or other aspects of the present general inventive concept are achieved by providing a control method of a display apparatus including a video signal processing unit to process input first and second video signals in a PIP mode, and a display unit on which the first and the second video signals processed by the video signal processing unit are displayed, the control method comprising processing the first and the second video signals in the PIP mode when a PIP function is selected, and displaying the first video signal as a main screen and the second video signal as a sub screen on the display unit, and adjusting transparency of the sub screen when predetermined conditions are satisfied.

The adjustment of the transparency may comprise lowering a display tone of the sub screen to a predetermined level when no second video signal corresponding to the sub screen is input.

The control method may further comprise turning off the PIP function when no second video signal corresponding to the sub screen is input for a predetermined time.

The control method may further comprise turning on the PIP function when the second video signal corresponding to the sub screen is input.

The foregoing and/or other aspects of the present general inventive concept are also achieved by providing a display apparatus comprising a video signal processing unit to process input first and second video signals in a PIP mode, and a display unit on which the first and second video signals processed by the video signal processing unit are displayed, comprising a control unit to control the video signal processing unit to process the first and the second video signals in the PIP mode when a PIP function is selected, to display the first video signal on the display unit as a main screen and the second video signal as a sub screen, and to control transparency of the sub screen according to predetermined conditions.

The control unit may lower a display tone of the sub screen to a predetermined level when no second video signal corresponding to the sub screen is input.

The control unit may turn off the PIP function when no second video signal corresponding to the sub screen is input for a predetermined time.

The control unit may turn back on the PIP function when the second video signal corresponding to the sub screen is input.

The foregoing and/or other aspects of the present general inventive concept are also achieved by providing a display apparatus supporting a PIP function, comprising a display element to function in a normal mode when a first video signal is displayed on an entire area of the display element, in a PIP mode in which the first signal is displayed on the entire area of the display element except for a sub screen region of the display element where a second video signal is displayed, and in an adjusted PIP mode in which brightness of the second video signal is lowered so that both the first video signal and the second video signal are visible in the sub screen region, and a control unit to control the display element to switch between the normal mode, the PIP mode and the adjusted PIP mode, based on predetermined conditions.

The foregoing and/or other aspects of the present general inventive concept are also achieved by providing a control method of a display apparatus supporting a PIP function, the control method comprising selecting a PIP function to display images according to a first video signal on an entire area of a display element except a sub screen region where are displayed images according to a second video signal, and adjusting transparency in the sub screen region by lowering brightness of the second video signal when predetermined conditions are satisfied.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram of a display apparatus according to an exemplary embodiment of the present general inventive concept; and

FIG. 2 is a flowchart of a control method according to an exemplary embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

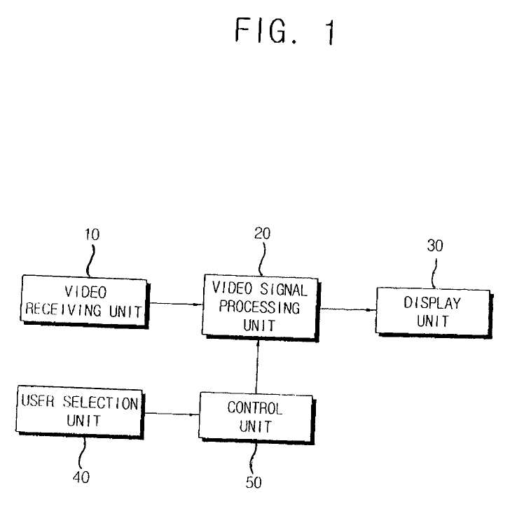

FIG. 1 is a block diagram of a display apparatus according to an exemplary embodiment of the present general inventive concept. As illustrated in FIG. 1, the display apparatus comprises a video receiving unit 10, a video signal processing unit 20, a display unit 30, a user selection unit 40 and a control unit 50.

The video receiving unit 10 receives a broadcast signal, and a signal from an external source. The video receiving unit 10 comprises an antenna to receive the broadcast signal, and a tuner to select a broadcast channel. The video receiving unit 10 may further comprise an input terminal into which a connection cable connected to the external source is inserted. For example, the video receiving unit 10 may comprise input terminals, such as S-video, Component, PC-signal, digital video interface (DVI)-signal, and High Definition Multimedia Interface (HDMI) corresponding to a variety of external sources.

The video signal processing unit 20 processes the signals input through the video receiving unit 10 to convert the input signals into signals that can be displayed in a PIP mode by the display unit 30.

The video signal processing unit 20 may comprise a decoder to decode a composite video baseband signal (CVBS) or S-video signal, an A/D converter to convert analog signals of a Component signal or PC-signal into digital signals, and a transition minimized differential signaling (TDMS) receiving unit to divide DVI-signals into RGB digital signals and H/V signals.

In addition, the video signal processing unit 20 comprises a scaler to transform the video signals adaptively to a vertical frequency, a resolution and an aspect ratio to correspond to an output standard of the display unit 30.

Here, the video signal processing unit 20 has process blocks to process a first video signal corresponding to the main screen and a second video signal corresponding to the sub screen, to be displayed in the PIP mode. The first video signal and the second video signal are scaled according to information regarding a predetermined position and size of the sub screen and a display size set in advance through the process blocks.

The video signal processing unit 20 processes the first video signal corresponding to the main screen to be adapted to the size of the display unit 30, processes the second video signal corresponding to the sub screen, scales them according to the predetermined sub screen display position and respective display size, and then synthesizes two types of signals to be output one for the main screen and one for the sub screen.

For example, if a PC signal is currently displayed on the main screen, when a user selects a PIP function to display a TV video signal of a specific channel on the sub screen, the control unit 50 controls the video signal processing unit 20 to process the TV video signal of the selected channel for the sub screen and to scale the TV video signal according to set information regarding the sub screen display position and display size, and to synthesize the TV video signal with the PC signal to be output to the display unit 30.

The display unit 30 displays the received signals from the video signal processing unit 20 as an image. The display unit 30 comprises a display panel on which the image is displayed, and a panel driving unit to control driving of the display panel. The display unit 30 according to the present embodiment may includes various types of display modules, such as a digital light processing (DLP) device, a liquid crystal display (LCD), a plasma display panel (PDP), etc.

The user selection unit 40 is designed to allow a user to select a PIP function, and comprises a menu key provided on a main casing of the display apparatus, and a key signal generating unit to generate a key signal corresponding to a selection input through the menu key. The user selection unit 40 may be provided with input means separately connected, such as a mouse, a keyboard, or a wireless remote control.

When the PIP function is selected through the user selection unit 40, the control unit 50 controls the video signal processing unit 20 to thereby process the first and the second video signals in the PIP mode, controls the display unit 30 to display the processes signals, and adjusts transparency of the sub screen when predetermined conditions are satisfied. The control unit 50 may include a controller, such as a microcomputer.

The control unit 50 can adjust the transparency of the sub screen by adjusting a display tone, that is, the brightness of the sub screen. Operations of the control unit 50 will be described below in more detail.

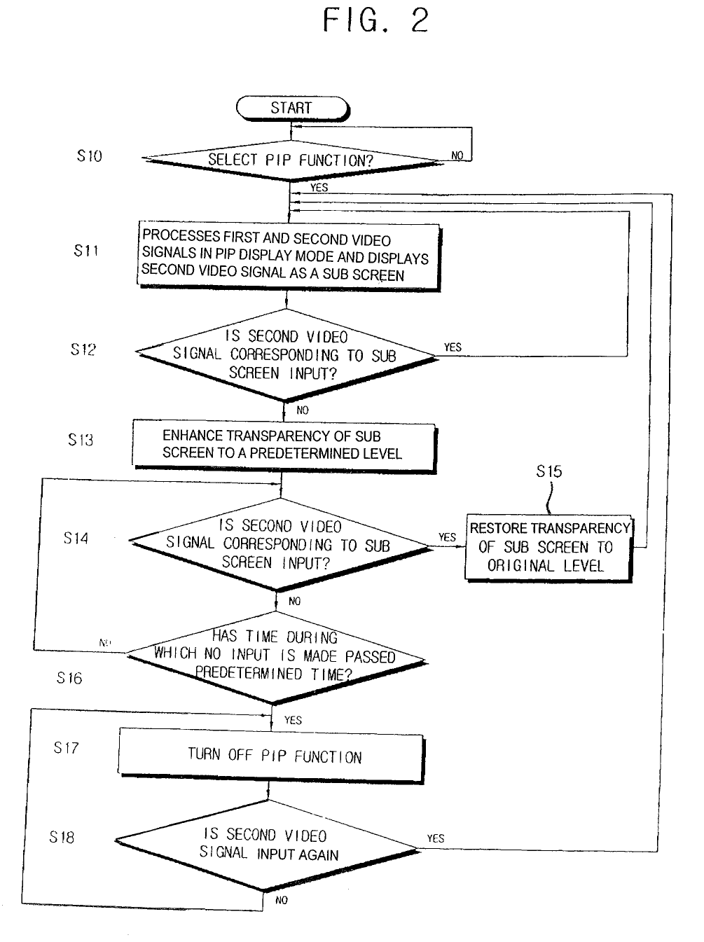

A control method according to an exemplary embodiment of the present general inventive concept will be described with reference to FIG. 2. The method of FIG. 2 may be performed in the display apparatus of FIG. 1.

As illustrated in FIG. 2, when a user selects a PIP function using a menu key of the user selection unit 40 at operation S10, the control unit 50 receives a corresponding key signal from the user selection unit 40, and controls the video signal processing unit 20 to thereby process the first and the second video signals input through the video receiving unit 10 in the PIP mode and controls the display unit 30 to display the first and the second video signal as the main screen and the sub screen, at operation S11.

When the control unit 50 determines that the second video signal corresponding to the sub screen is not input at operation S12, the control unit 50 enhances the transparency of the sub screen to a predetermined level at operation S13. That is, the control unit 50 lowers the display tone of the sub screen to a half tone mode so that the main screen and the sub screen displayed on the display unit 30 are overlapped and visible in a region of the display where the sub screen is displayed. The user may set a different level of the display tone of the sub screen using a predetermined menu.

The control unit 50 continuously monitors whether the second video signal corresponding to the sub screen is input at operation S14. When the control unit 50 determines that the second video signal is input, the control unit 50 enhances the display tone of the sub screen to thereby recover the transparency of the sub screen to an original level at operation S15. When the transparency of the sub screen is restored to the original level, the main screen is not visible in the region where the sub screen is displayed.

When a time interval during which the second video signal is not input exceeds a predetermined time set in advance at operation S16, the control unit 50 turns off the PIP function at operation S17. That is, by turning off the PIP function the sub screen is not display anymore, and only the main screen corresponding to the first video signal is displayed on the display unit 30.

The predetermined time may have different values depending on types of display apparatuses, and a menu to allow a user to set the predetermined time may be provided.

When the control unit 50 determines that the second video signal is input at operation S18, the control unit 50 automatically turns on the PIP function and controls the video signal processing unit 20 to thereby process the second video signal input and the first video signal in the PIP mode and the display unit 30 to display the first video signal in the main screen and the second video signal in the sub screen, at operation S11.

According to the above described control method, although a user selects the PIP function, the display tone of the sub screen is lowered when no video signal corresponding to the sub screen is input, and the PIP function is turned off when no video signal corresponding to the sub screen is input for the predetermined time, thereby allowing the user to conveniently view the main screen.

According to another exemplary embodiment of the present general inventive concept, when the second video signal corresponding to the sub screen is not input, the control unit 50 lowers the display tone of the sub screen to thereby enhance the transparency thereof, and the control unit 50 may gradually lower the display tone of the sub screen according to a lapse of time during which the second video signal is not input. That is, as the time during which no second video signal is input passes, the transparency of the sub screen is gradually enhanced, and thus, the user can view the main screen more clearly.

According to the above described exemplary embodiments of the present general inventive concept, the transparency of the sub screen is adjusted when no second video signal is input or as the time lapses without receiving the second video signal. However, the transparency of the sub screen may be adjusted under various conditions, including according to an input from a user.

As described above, according to various embodiments of the present general inventive concept, there are provided a display apparatus and a control method thereof, capable of improving a user's convenience in viewing a main screen in a PIP mode, by adjusting transparency of a sub screen.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A control method of a display apparatus including a video signal processing unit to process input first and second video signals in a PIP mode, and a display unit on which the first and the second video signals processed by the video signal processing unit are displayed, the control method comprising:
processing the first and the second video signals in the PIP mode when a PIP function is selected, and displaying the first video signal as a main screen and the second video signal as a sub screen on the display unit; and
adjusting transparency of the sub screen when predetermined conditions are satisfied.

2. The control method according to claim 1, wherein the adjusting of the transparency comprises lowering a display tone of the sub screen to a predetermined level when the second video signal corresponding to the sub screen is not input.

3. The control method according to claim 1, further comprising:
turning off the PIP function when the second video signal corresponding to the sub screen is not input for a predetermined time.

4. The control method according to claim 3, further comprising:
turning on the PIP function when the second video signal corresponding to the sub screen is input.

5. A display apparatus comprising:
a video signal processing unit to process input first and second video signals in a PIP mode; and
a display unit on which the first and second video signals processed by the video signal processing unit are displayed, comprising:
a control unit to control the video signal processing unit to process the first and the second video signals in the PIP mode when a PIP function is selected, to display the first video signal on the display unit as a main screen and the second video signal as a sub screen, and to control transparency of the sub screen according to predetermined conditions.

6. The display apparatus according to claim 5, wherein the control unit lowers a display tone of the sub screen to a predetermined level when the second video signal corresponding to the sub screen is not input.

7. The display apparatus according to claim 5, wherein the control unit turns off the PIP function when the second video signal corresponding to the sub screen is not input for a predetermined time.

8. The display apparatus according to claim 7, the control unit turns back on the PIP function when the second video signal corresponding to the sub screen is input.

9. A display apparatus supporting a PIP function, comprising:
a display element to function in a normal mode when a first video signal is displayed on an entire area of the display element, in a PIP mode in which the first signal is displayed on the entire area of the display element except for a sub screen region of the display element where a second video signal is displayed, and in an adjusted PIP mode in which brightness of the second video signal is lowered so that both the first video signal and the second video signal are visible in the sub screen region; and
a control unit to control the display element to switch between the normal mode, the PIP mode and the adjusted PIP mode, based on predetermined conditions.

10. The display apparatus according to claim 9, wherein the control unit switches the display element from the PIP mode to the adjusted PIP mode if the second video signal is not input and switches back the display element from the adjusted PIP mode to the PIP mode if the second video signal is input.

11. The display apparatus according to claim 10, wherein the control unit switches the display element from the adjusted PIP mode to the normal mode if the second video signal is not input for a predetermined time interval and switches the display element from the normal mode to the PIP mode when the second video signal is subsequently received.

12. The display apparatus according to claim 11, wherein the control unit switches the display element from the adjusted PIP mode to the normal mode by gradually lowering brightness of the second video signal.

13. The display apparatus according to claim 9, further comprising:
a video receiving unit to receive a first and a second video input signal;
a video processing unit to process the first and second video input signals into the first and second video signals to be displayed by the display element; and
a user interface connected to the control unit to allow a user to turn on/off the PIP function so that when the PIP function is turned off using the user interface the display element functions only in the normal mode.

14. The display apparatus according to claim 13, wherein the video receiving unit is capable of receiving two or more video input signals simultaneously and comprises a combination of at least two of an antenna and a tuner to receive TV broadcast signal, an S-video connector, a Component connector, PC-signal connector, a digital video interface (DVI) connector, and a High Definition Multimedia Interface (HDMI).

15. The display apparatus according to claim 13, wherein the video processing unit comprises at least one of a decoder to decode a composite video baseband signal (CVBS) or S-video signal, an A/D converter to convert analog signals of Component signal or PC-signal into digital signals, a transition minimized differential signaling (TDMS) receiving unit to divide DVI-signals into RGB digital signals and H/V signals.

16. The display apparatus according to claim 13, wherein the video processing unit comprises a scaler module to transform the first and second video signals adaptively to a vertical frequency, a resolution and an aspect ratio to correspond to an output standard of the display element, position and size of the sub screen region.

17. The display apparatus according to claim 13, wherein the user interface comprises a selection unit to allow user to input selections and a signal generation unit to generate and output signals according to the selections.

18. The apparatus according to claim 17, wherein the selection unit comprises one of a keyboard, a mouse and a wireless remote control.

19. The apparatus according to claim 9, wherein the display element comprises one of a digital light processing device, a liquid crystal display and a plasma display panel.

20. A control method of a display apparatus supporting a PIP function, the control method comprising:
displaying images according to a first video signal on an entire area of a display element except for a sub screen region where are displayed images according to a second video signal; and
adjusting transparency in the sub screen region by lowering brightness of the second video signal when predetermined conditions are satisfied.

21. The control method of claim 20, wherein the predetermined conditions are one of receiving no second video signal, and receiving a user command to adjust the transparency.

22. The control method of claim 20, wherein the adjusting of the transparency comprises lowering the brightness of the second video signal from a normal value to a predetermined brightness value or a user set brightness value.
